(19) United States
(12) Patent Application Publication
(10) Pub. No.: US 2014/0075744 A1
(43) Pub. Date: Mar. 20, 2014

(54) Pressing Of Transformer Windings During Active Part Drying

(71) Applicants: Jan Anger, Ludvika (SE); Uno Gafvert, Vasteras (SE); Orlando Girlanda, Vasteras (SE); David Goeransson, Bad Honnef (DE); Zdenko Cabrajic, Ludvika (SE)

(72) Inventors: Jan Anger, Ludvika (SE); Uno Gafvert, Vasteras (SE); Orlando Girlanda, Vasteras (SE); David Goeransson, Bad Honnef (DE); Zdenko Cabrajic, Ludvika (SE)

(21) Appl. No.: 14/091,590

(22) Filed: Nov. 27, 2013

Related U.S. Application Data
(63) Continuation of application No. PCT/EP2012/059933, filed on May 28, 2012.

(30) Foreign Application Priority Data
Jun. 1, 2011 (EP) 11168339.7

(51) Int. Cl. H01F 41/02

(52) U.S. Cl. CPC H01F 41/0206
USPC 29/606; 29/729

(57) ABSTRACT

A method and arrangement for pressing of windings assembled onto a transformer. The method includes applying pressing force on the windings, and controlling the pressing force on the windings during drying of transformer active part. Thus, before the drying process commences, the windings are assembled onto the transformer core and a pressing force is applied to the windings assembled onto a respective transformer core limb, wherein an individual pressing force is applied to the respective winding. This individual pressing force applied to the respective winding is then controlled during the process of drying the transformer active part. The windings will as a result advantageously be effectively compressed onto the core and stabilized.

### FIELD OF THE INVENTION

The present invention generally relates to a method and arrangement of pressing of windings assembled onto a transformer.

### BACKGROUND OF THE INVENTION

It is important that transformer windings are well-clamped and robust during transport to site and subsequent operation. To obtain this, the windings are compressed axially and clamped in position on the transformer core after drying the transformer active part. Drying is undertaken since cellulose insulation of the winding must be free from moisture. Moisture in the insulation of the windings deteriorates transformer operation; first of all, the dimensions of the cellulose-clad windings change as moisture leaves the cellulose material. Second, the material may partly lose its insulating effect with subsequent electrical problems in the transformer.

However, notwithstanding transformer active part drying, the clamping force of the press plates applied to the windings is reduced with time because of mechanical relaxation of the insulation material. This relaxation is accelerated by heating and cooling since temperature expansion of the cellulose insulation is many times greater than that of copper and steel. Traditionally, to reduce the relaxation, the windings are pressed and thus compacted separately in the winding work shop before and after drying of the windings. Alternatively, as is shown in e.g. U.S. Pat. No. 4,255,868, the windings are compacted by pressing them with a constant axial pressure during drying of the winding.

A problem with both these approaches is that a complex and time consuming process is used for the production of the transformer. A further problem is that a part of the stabilizing effect on the windings is lost during the following work to assemble the windings on the transformer and during the drying of the active part.

DE 196 06 252 discloses pressing of windings and cores for high power high-voltage choke coils and transformers. After assembly of the transformer active part, the active part is pressed with a force of a first magnitude, and after drying the active part is pressed with a force of a second, higher magnitude. In DE 196 06 252, when pressing the windings, an upper and lower press plate are used for simultaneously compressing all windings.

### SUMMARY OF THE INVENTION

A general object of the present invention is to solve or at least mitigate the above described problems in the art.

In a first aspect of the present invention this object is achieved by a method of pressing of windings assembled onto a transformer, comprising applying pressing force on a winding assembled onto a respective transformer core limb, wherein an individual pressing force is applied to the respective winding, and controlling the individual pressing force on the respective winding during drying of transformer active part.

In a second aspect of the present invention this object is achieved by an arrangement for pressing of windings assembled onto a transformer core, Further, the arrangement comprises a plurality of pressure applying means arranged to apply pressure to the press plates such that an individual pressing force is applied to the respective winding, wherein the pressure applying means are arranged such that the pressing force applied to the respective winding is controlled during drying of the transformer active part.

Thus, before the drying process commences, the windings are assembled onto the transformer core and a pressing force is applied to the windings. This pressing force is then controlled during the process of drying the transformer active part. The windings will as a result advantageously be effectively compressed onto the core and stabilized. This will subsequently lead to short lead time in the production. The individual pressing force applied to the respective winding is approximately constant throughout the process, even though slight variations in pressure may occur.

A further advantage is that an individual pressing force is applied to the winding assembled onto the respective transformer core limb. In case the windings are different in length, different pressing forces can be applied to the respective winding.

In an embodiment of the present invention, a set of windings is assembled on the respective transformer limb. An advantage related to the pressing of a set of windings where each winding set is assembled onto a respective limb of the transformer core, is that the same clamping pressure is applied to the respective winding set. Where pressing force is applied to a plurality of winding sets, the pressing force is typically applied simultaneously to all the winding sets.

In an embodiment of the present invention, wedging is performed after the transformer active part has been dried. To this end, insulation material is inserted between the windings and a transformer core clamp such that compacting of the windings can be maintained when the applied pressing force on the windings is released after the transformer active part drying is completed. The wedging performed in this embodiment facilitates maintenance of the clamping force on the windings when the force from the pressure applying means is released.

In a further embodiment of the present invention, the pressure applying means are hydraulic jacks. The hydraulic jacks advantageously allow a very exact control of the pressure applied.

In yet another embodiment of the present invention, the pressure applying means are wedge pressing jacks, each comprising a first wedging member, a second wedging member, jack operating means and expansion elements arranged between the first and second wedging members. The expansion elements are arranged to cooperate with the jack operating means, and further arranged to act on the respective first and second wedging member so as to selectively expand and collapse upon operation of the jack operating means. The wedge pressing jack is inserted between the upper core clamp and at least one of the respective upper press plates and is subsequently caused to expand for pressing the windings. One or more wedge pressing jacks could be inserted between the upper core clamp and the respective upper press plate. A number of advantages are associated with the wedge pressing jack according to embodiments of the present invention. First, vertical adjustment of the windings can be carefully controlled. Secondly, pressing by means of the wedge pressing jack requires less space in the transformer. Further, wedge jack pressing is more ergonomic and less labor-intensive.

In further embodiments of the present invention, the windings, but not the transformer core, are set in fluid communication with a cooling element, such as dry air. Thus, after drying has been undertaken, but before wedging is performed and the pressing force is released, the windings are cooled by dry, cold air in order to further improve clamping and stability of the windings.

In the art, clamping of the windings onto the transformer core is typically performed when both the transformer core and the windings are still hot from drying in a vapor phase process. Cellulose has a larger thermal expansion coefficient than steel of the core and copper of conductors. Thus, some clamping pressure is lost in the art when the active part cools down due to the fact that the cellulose-clad windings contract more than the steel of the transformer core.

Hence, this embodiment is advantageous since it will result in a better preserved winding clamping pressure. Thus, either a higher winding clamping pressure can be attained with the same pressing force, or a smaller pressing force can applied to attain the same winding clamping pressure.

Additional features and advantages will be disclosed in the following.

### BRIEF DESCRIPTION OF THE DRAWINGS

Embodiments of the present invention and advantages thereof will now be described by way of non-limiting examples, with reference to the accompanying drawings in which:

FIG. 1 illustrates pressing of an active part of a transformer according to an embodiment of the present invention;

FIG. 2 is a cross sectional view of the structure shown in FIG. 1;

FIG. 3 illustrates cooling of windings assembled onto a transformer according to an embodiment of the present invention; and

FIGS. 4A and B illustrate a wedge pressing jack according to an embodiment of the present invention.

### DETAILED DESCRIPTION OF THE INVENTION

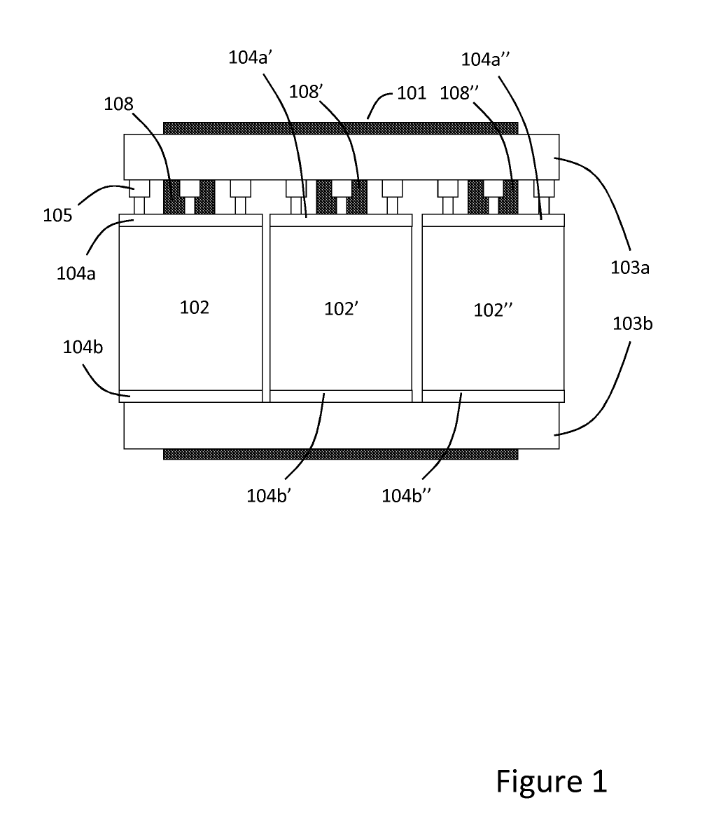

FIG. 1 illustrates pressing of an active part of a transformer, i.e. the pressing of windings mounted onto a transformer core, according to an embodiment of the present invention. FIG. 1 shows a three-phase transformer core 101 thus having three limbs 108, 108′, 108″ with a set of windings 102, 102′, 102″ concentrically mounted on each limb. Further, upper 103a and lower 103b core clamps are mounted on the core to stabilize and keep the core together. The core clamps are further used to assist in applying an individual clamping force on the respective winding set 102, 102′, 102″. Upper and lower press plates 104a, 104a′, 104a″ and 104b, 104b′, 104b″, respectively, are arranged to apply an individual pressing force on the respective winding sets during drying of the active part of the transformer, and to control the clamping force applied on the winding sets 102, 102′, 102″ after drying when the transformer is to be transported as well as when the transformer is in operation. The upper press plates 104a, 104a′, 104a″ are typically movable, while the lower press plates 104b, 104b′, 104b″ are fixed. Finally, hydraulic jacks 105 are arranged between the upper core clamp 103a and the upper press plates 104a, 104a′, 104a″ to apply an individual axial pressing force on the respective winding sets via the press plates.

In an alternative embodiment, the upper press plates 104a, 104a′, 104a″ are fixed while the lower press plates 104b, 104b′, 104b″ are movable. In such an alternative embodiment, the hydraulic jacks 105 are arranged between the lower core clamp 103b and the lower press plates 104b, 104b′, 104b″.

The hydraulic jacks allow a very exact control of the pressure applied. A number of hydraulic jacks are used for each set of windings. Further, the core in itself is employed to support the set of windings during pressing, and usage of press rods as is common in the art can thus be avoided.

Applying an individual pressing force to the respective winding set assembled onto the transformer core limbs is advantageous since the pressing force applied to each set of windings can be individually controlled. Assuming e.g. that the centrally arranged set of windings 102′ is slightly shorter in a vertical direction as compared to the other two winding sets 102 and 102″, it would still be possible to adjust the pressing force to the respective winding set on which it is applied. Thus, by providing an individual pressing force to the respective winding set, compression can still effectively be attained.

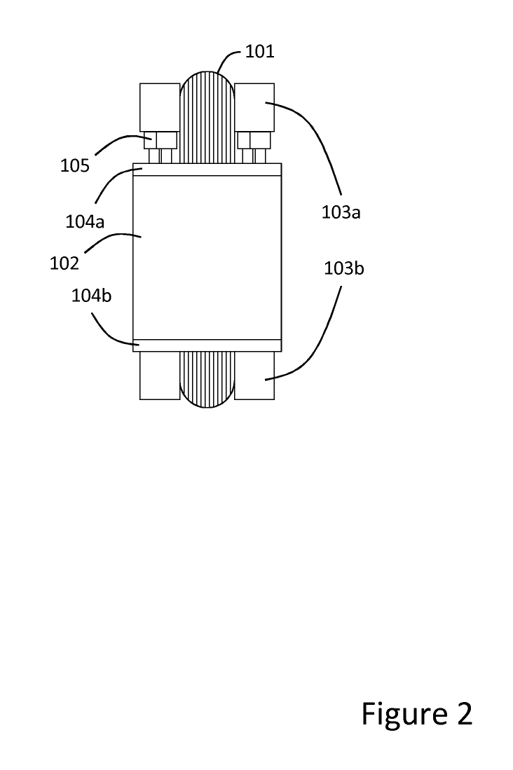

FIG. 2 is a cross sectional view of the structure shown in FIG. 1, where the same reference numerals denote the same elements.

In practice, anything from one to about a hundred hydraulic jacks are used per transformer depending on transformer size. The jacks 105 are arranged at the upper core clamp 103a before active part drying commences. Each jack is connected to a respective pressure hose which is connected, via oven wall connectors, to a hydraulic pump located outside the oven in which the transformer is placed for drying of the active part. Typically, the well-established vapor phase drying technique is employed. The pump is arranged with flow control such that press force and jack displacement can be controlled from outside the oven.

A pressure is applied to the jacks and kept approximately constant during the entire active part drying process. The upper and lower press plates 104a, 104b thus compacts the respective winding set 102 during drying, and winding height is monitored continuously and automatically. After the drying is finished, the transformer is taken out of the oven with winding pressure maintained by the jacks and the press plates. Thereafter, so called wedging is performed, i.e. insulating material is inserted between the upper core clamp 103a and the respective winding set, in order to have the windings compacted before the jacks are removed.

The insulation material inserted between the upper core clamp 103a and the upper press plate 104a thus facilitates compacting of the windings 102 (together with opposing lower clamp 103b and lower press plate 104b) after the drying process is completed and the jacks 105 have been removed. The transformer can finally be placed in a tank for oil filling and factory acceptance testing before transport to site.

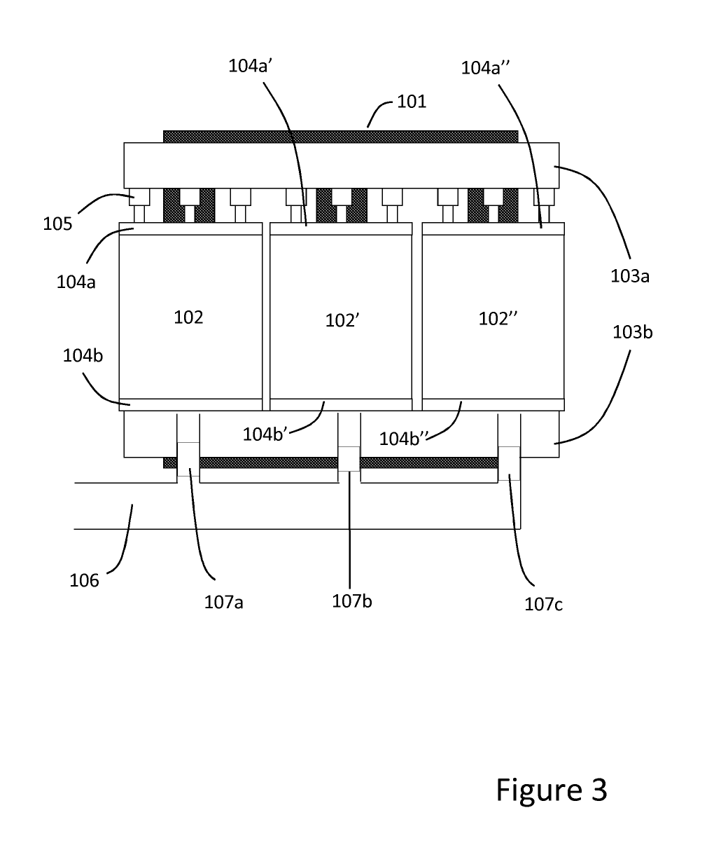

In a further embodiment of the present invention, with reference to FIG. 3, after drying has been undertaken, but before wedging has been performed and the jacks 105 have been removed, the windings—but not the core—are cooled by dry, cold air in order to further improve clamping and stability of the windings 102, 102′, 102″. Thus, the active part is taken out of the vapor phase oven while still being hot. The jacks 105 are still mounted between the upper core clamp 103a and the respective upper press plate 104a, 104a′, 104a″ such that an individual pressing force is applied to the winding sets 102, 102′, 102″ to keep them compacted. The windings are then actively cooled by circulating cold, dry air in a cooling duct arrangement 106. Thus, the windings are set into fluid communication with a cooling element exhausted from a respective outlet 107a, b and c. In this particular exemplifying embodiment of the present invention, the cooling element consists of air. However, a skilled person realizes that other gases or even liquids can be used. The cooling duct arrangement 106 and the outlets 107a-c are arranged such that air is discharged locally about the winding sets 102, 102′, 102″ without cooling the transformer core 101. The height of the cellulose-clad windings is reduced by thermal contraction of the cellulose, as well as of the copper in the winding although the copper contracts to a much smaller degree than the cellulose. Further, the dry air flow prevents build-up of moisture in the cellulose. The cooling duct arrangement 106 renders it possible to cool the windings 102, 102′, 102″ without cooling the transformer core 101 itself. Hence, the core 101 remains thermally expanded relative to the windings. As can be seen, a winding assembly comprising a set of windings, insulating cellulose and winding end pieces is mounted onto the respective transformer core limb, before pressing and drying commences. It should be noted that any appropriate insulating material can be used, such as e.g. the flame-resistant insulating material NOMEX.

The jacks 105 apply the pressing force onto the upper press plates 104a until the winding temperature is sufficiently reduced, typically close to room temperature. That is, the pressing force is applied to a point where no or very little further deformation of the windings can occur. Thereafter, wedging can be performed and the jacks 105 can be removed.

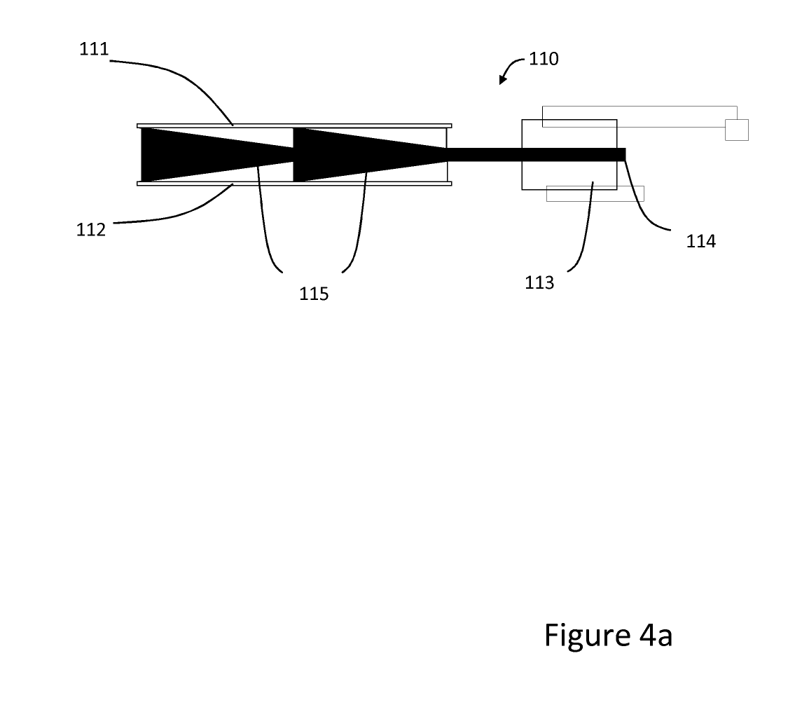

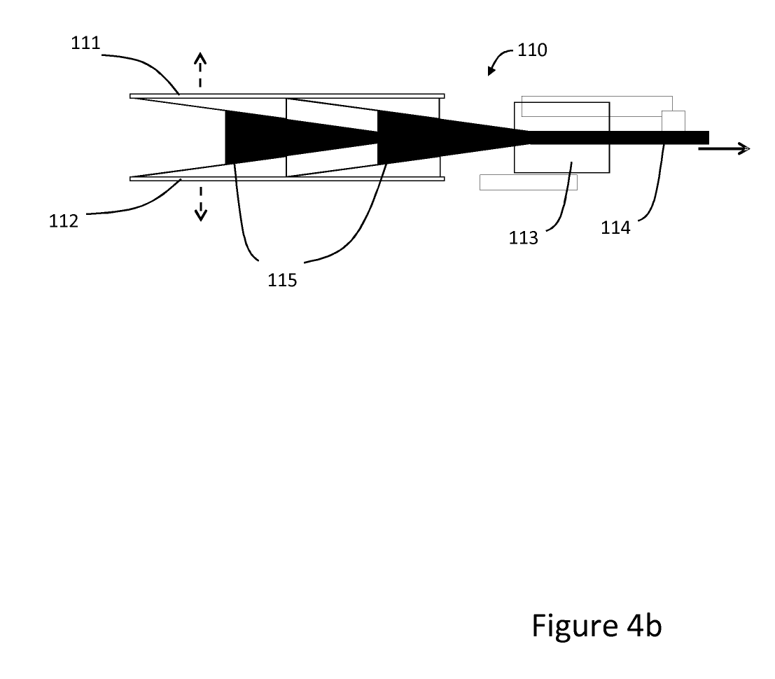

With reference to FIGS. 4a and b, in an alternative embodiment of the present invention, the hydraulic jacks 105 are replaced by wedge pressing jacks 110, each comprising two longitudinally extending wedging members 111, 112, optionally a handle 113, and a jack operating means exemplified in the form of a knob 114 which is operated such as to cause the wedging members 111, 112 to selectively expand or collapse in a transversal direction as indicated by the arrows in FIG. 4b. Expansion elements 115 are arranged between the first 111 and second 112 wedging members and further being arranged to cooperate with the knob 114, which expansion elements act on the respective first and second wedging member such that the first and second wedging members selectively can be caused to collapse and expand upon operation of the knob.

As is shown in FIG. 4b, by pulling the knob 114, the two wedging members 111, 112 expand. If the knob 114 subsequently is pushed in a direction of the handle 113, the two wedging members 111, 112 collapse.

Advantageously, with reference to FIGS. 3 and 4, a wedge pressing jack 110 is inserted between the upper core clamp 103a and the respective upper press plate 104a, 104a′, 104a″ for compacting the windings 102, 102′, 102″ (in cooperation with the opposing lower clamp 103b and the lower press plates 104b, 104b′, 104b″). Thus, in this particular example, at least one wedge pressing jack 110 is used for each winding set 102, 102′, 102″. It can further be envisaged that a plurality of wedge pressing jacks 110 are inserted between the upper core clamp and a given upper press plate. When operating the knob 114, the two wedging members 111, 112 will expand and apply a pressure to the upper core clamp 103a and the upper press plate 104a, respectively. Consequently, a pressure is applied to the winding set 102, 102′, 102″, which is compacted.

The skilled person in the art realizes that the present invention by no means is limited to the examples described hereinabove. On the contrary, many modifications and variations are possible within the scope of the appended claims.

1. A method of pressing of windings assembled onto a transformer core, comprising:
applying pressing force on a winding assembled onto a respective transformer core limb, wherein an individual pressing force is applied to the respective winding; and
controlling the individual pressing force on the respective winding during drying of transformer active part.

2. The method of claim 1, further comprising:
setting the windings in fluid communication with a cooling element.

3. The method of claim 2, wherein said cooling element is cold dry air.

4. The method of claim 2, wherein the setting of the windings in fluid communication with a cooling element further comprises:
preventing the transformer core from coming into contact with the cooling element.

5. The method of claim 1, further comprising:
inserting insulation material between the respective winding and a transformer core clamp such that compacting of the windings can be maintained when the applied pressing force on the windings is released after the transformer active part has been dried.

6. The method of claim 1, wherein a set of windings is assembled on the respective transformer core limb and pressed.

7. An arrangement for pressing of windings assembled onto a transformer core, comprising:
an upper and a lower press plate arranged at a respective end face of a winding assembled onto the respective transformer core limb;
a plurality of pressure applying means arranged to apply pressure to the press plates such that an individual pressing force is applied to the respective winding; wherein
the pressure applying means are arranged such that the pressing force applied to the respective winding is controlled during drying of transformer active part.

8. The arrangement of claim 7, wherein
said upper press plates are arranged to be movable, and
said lower press plates are arranged to be fixed,
wherein the pressure applying means are arranged to apply pressure to the movable upper press plates such that the individual pressing force is applied on said respective winding.

9. The arrangement of claim 7, wherein
said lower press plates are arranged to be movable, and
said upper press plates are arranged to be fixed,
wherein the pressure applying means are arranged to apply pressure to the movable upper press plates such that the individual pressing force is applied on said respective winding.

10. The arrangement of claim 7, said pressure applying means being hydraulic jacks.

11. The arrangement of claim 7, said pressure applying means being wedge pressing jacks, each wedge pressing jack comprising:
a first wedging member;
a second wedging member;
jack operating means;
expansion elements arranged between the first and second wedging members and further being arranged to cooperate with the jack operating means, said expansion elements being arranged to act on the respective first and second wedging member so as to selectively expand and collapse upon operation of the jack operating means.

12. The arrangement of claim 7, further comprising:
a duct arrangement arranged to set the windings in fluid communication with a cooling element.

13. The arrangement of claim 12, wherein:
said duct arrangement further is configured to prevent the transformer core from coming into contact with the cooling element when cooling the winding.

14. The arrangement of claim 7, further comprising:
a drying oven arranged to dry the transformer active part.

15. The arrangement of claim 7, wherein a set of windings is assembled on the respective transformer core limb and pressed.
